(19) United States
(12) Patent Application Publication
(10) Pub. No.: US 2009/0072955 A1
(43) Pub. Date: Mar. 19, 2009

(54) WEARABLE COIN-SIZED SENSORY DEVICES, AND RELATED SYSTEMS AND METHODS, PROVIDING IMMEDIATE WIRELESS NOTIFICATION OF ACTIVITIES ON SEPARATE ELECTRONIC DEVICES

(76) Inventor: Patrick Kearney Cary, Chicago, IL (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(21) Appl. No.: 11/856,126

(22) Filed: Sep. 17, 2007

(51) Int. Cl. H04B 3/36

(52) U.S. Cl. 340/407.1

(57) ABSTRACT

Wearable coin-sized sensory devices, and related systems and methods, providing immediate wireless notification of activities occurring on separate electronic devices, such that the invention can be worn in contact or near contact with the user's skin, which does not require the user to replace, reconfigure or retrofit items already possessed by the user and worn on the body, and which does not disturb others in the vicinity of the user. When one of the designated separate electronic devices not actually held in the user's hand or face-to-face with the user, e.g., emits a wireless signal as a result of an occurrence on such separate electronic device, the invention senses such wireless signal and immediately produces a tactile indication, silent or near-silent, to the user. The invention is merely coin-sized and thus can be versatility attached or affixed to items in contact or near contact with the user's body in multiple ways.

### CROSS-REFERENCE TO RELATED APPLICATIONS

Not applicable.

### FEDERALLY SPONSORED RESEARCH OR DEVELOPMENT

Not applicable.

### SEQUENCE LISTING OR PROGRAM

Not applicable.

### BACKGROUND OF THE INVENTION

The field of endeavor generally relates to sensory notification devices which wirelessly receive notifications of activities occurring on separate electronic devices.

Electronic devices, including portable ones, are widely used in this day and age, and will continue to be used long into the future. Such devices include, but certainly are not limited to, cellular telephones, hand-held computers, electronic mail devices, text message devices, walkie-talkies, digital music players, portable televisions, portable cameras, and video recorders.

Many electronic devices, whether configured to perform few functions or several, provide sensory indications of various activities occurring on the devices, activities such as telephone calls, electronic mail, texts, significant calendar warnings, battery deficiencies and storage limits, just to name a few. Users, however, typically only becomes cognizant of such indications and the corresponding occurrences when the devices are in relatively close physical proximity of the user. For example, a device receiving a telephone call, a text or an electronic mail message, might provide an auditory ring, a vibration and/or a blinking light. Often times, however, unless the device is actually held in the hand of the user or outside of a user's clothing pocket and proximate to the user, the sensory indication is not immediately appreciated. While some users carry portable electronic devices in belt holsters, providing the users a greater likelihood that the sensory indication will be appreciated immediately, many users simply carry portable electronic devices in pockets, purses, bags or briefcases for practical reasons. Thus, although electronic devices are often times carried on or in close proximity to the user's person, such does not always allow for immediate appreciation of the sensory indications given by the devices. In such cases only if the electronic devices are intermittently checked will users ultimately appreciate timely the indications issued therefrom.

Further, there are practical limits on the extent of the indications electronic devices can emit. For example, the cited problem cannot be solved merely by making an auditory ring extremely loud, a vibration on the electronic device extremely vibrant, or a blinking light extremely bright, as such would become a nuisance to not only the user, but also others in the vicinity of the user.

Thus there is a need for a device to immediately notify users of occurrences on separate electronic devices, such that the notification device can be worn in contact or near contact with the user's skin, which does not require the user to replace, reconfigure or retrofit items already possessed by the user and worn on the body, and which does not disturb others in the vicinity of the user. Existing art do not address this need. For example, some have suggested that a solution may lie in what is commonly referred to as a “Bluetooth™ watch”: a wrist-worn watch device which is configured, for example, to provide the user with a liquid crystal display readout of information received on a separate portable electronic device, such as a cellular telephone and/or text device. A user in such instance may receive a telephone call on the separate device, after which the Bluetooth™ watch would indicate on its liquid crystal display the identity of the caller's name and/or number. The Bluetooth™ watch user then typically has the option of responding to the incoming call, such as directing the call to voicemail or in some cases answering the call using the Bluetooth™ watch.

The problem with the Bluetooth™ watch, however, is the fact that to use such a device the user must replace his or her existing watch, which in many cases is possessed for its aesthetic or stylish value, rather than the actual ability to tell time. Thus a device is needed which will not require the replacement of the watch the user already owns. Further, since people typically keep separate portable electronic devices on their persons, in pockets or bags for example, there is no need for a watch to perform the functions the separate portable electronic devices already perform.

Other art are also insufficient to accomplish the aforementioned needs. For instance, U.S. Pat. No. 6,218,958 to Eichstaedt et al., 17 Apr. 2001, discloses a notification device that would generate “plural” tactile signals, each signal corresponding to a different separate “personal computing device,” and which would contain tactile elements “on” the housing. The art suggested in such patent, however, is impractical, as utilizing “plural” tactile signals would be significantly too bulky. Further, the tactile signal on the needed notification device must be in the housing, not “on” it, which then would increase the notification device's versatility, so that it could be worn in substantially more ways and/or affixed to substantially more items. Also, the needed device cannot be limited to providing notifications only from “personal computing devices,” as does U.S. Pat. No. 6,218,958.

U.S. Pat. No. 7,130,664 to Williams, 31 Oct. 2006, is also insufficient. The device suggested by such patent is confined to use with separate “telecommunications” devices, and the notification device either must be concealed on the user or “integral” to a bodily-worn personal accessory. The needed notification device, however, cannot be limited to “telecommunications” devices, but should be usable with any separate electronic device capable of transmitting a wireless signal of activities occurring on such separate device. Further, making the notification device concealed destroys versatility in its use; and requiring the device be “integral” to a bodily-worn accessory, and thus by definition a component of the bodily-worn accessory, means the device cannot be easily interchanged by the user, from a watch to a necklace for example.

There is also a need for a device to immediately notify users of activities on separate non-portable electronic devices, indeed any electronic device that is constructed or configured to emit a wireless signal. Myriad common electronic devices such as household appliances, televisions, room lights, thermostats, smoke alarms and gas meters, just to name a few, can be constructed or configured to emit wireless signals of occurrences. People need to be immediately notified if an emergency situation involves such electronic devices, such as an oven which has been in continuous use for an inordinate amount of time, or a triggered smoke alarm.

### SUMMARY

The disclosed invention addresses the foregoing needs. In accordance with one embodiment, the invention comprises a device, and concomitant systems and methods, for users of any separate electronic device which can generate a wireless signal of an occurrence or occurrences on such separate electronic device, such that the notification device is comprised of a coin-sized or smaller housing, which is physically unconnected to the separate electronic device, and which can be worn or affixed to an item in contact or near contact with the user's skin. Once significant or otherwise defined activities associated with the separate electronic device occur, the notification device provides an immediate silent or near silent tactile indication to the user.

The device is not limited to receiving wireless signals from portable electronic devices, such as cellular telephones, walkie-talkies, hand-held computers, electronic mail devices, text message devices, digital music players, portable televisions, portable cameras and video recorders, as the device can receive such signals, either directly or indirectly, as well from non-portable electronic devices, such as household appliances, televisions, room lights, thermostats, smoke alarms and gas meters, to name merely a few. In turn the user of the invention can be immediately notified of occurrences on such non-portable devices, including emergencies. For example, any common oven can be configured with a wireless device to emit a signal after the oven has been in continuous use after a certain amount time. The signal therefore could send a notification directly to the invention (or indirectly to the invention by notifying a portable electronic device kept in the proximity of the user), alerting the user that the oven has been mistakenly left on for more than a certain number of hours, averting disaster.

Pursuant to one placement aspect, the notification device, approximately the size of a coin, can be affixed by adhesive or magnet to the backside of any standard-sized watch worn by the user. The device can also be worn on the user's person, or affixed to an item already worn by the user, by a clip, pin, clasp and/or band. The interchangeability of the device furthermore allows the users to wear the device in multiple ways, such as attaching it to a watch but later clipping it to clothing.

Pursuant to the wireless aspect of the invention, the notification device can receive signals from separate and proximate electronic devices utilizing a WiBreem (also known as “ULP [Ultra Low Power] Bluetooth”) technology protocol. Other embodiments of the invention utilizes other standard wireless protocols, such as Bluetooth™, ZigBee™, Z-Wave™, IEEE 802.15.4, or a combination of one or more of any of those, or any other wireless protocols.

Pursuant to the powering aspect of the invention, the notification device can utilize a battery or kinetic energy.

Pursuant to the indication aspect of the invention, the notification device can provide a silent or near silent tactile indication to the user of signals generated by separate and proximate portable electronic devices via vibration, although other tactile indication could be used.

Other objects and features of the present invention will become apparent from the following detailed description considered in conjunction with the accompanying drawings. It is to be understood, however, that the drawings are designed solely for purposes of illustrations and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

FIG. 1 is an over and foreground perspective view of an embodiment of the disclosed invention showing the components of such embodiment.

FIG. 2A is a perspective view of a first embodiment of the invention, showing an inchoate affixment of such invention to a standard wrist watch.

FIG. 2B is a perspective view of the first embodiment of the invention, showing the complete affixment of such invention to a watch.

FIG. 3 is a schematic view of the first embodiment of the invention, showing it receiving a wireless signal from a separate electronic device and producing a tactile indication.

FIG. 4 is a perspective view of a second embodiment of the invention, showing it with a clip for affixment to any item in contact or near contact with the user's skin.

FIG. 5 is a perspective view of a third embodiment of the invention, showing it with a pin for affixment to any item in contact or near contact with the user's skin.

FIG. 6 is a perspective view of a fourth embodiment of the invention, showing it with a clasp for affixment to any item in contact or near contact with the user's skin.

FIG. 7 is a schematic view of a fifth embodiment of the invention, showing an inchoate placement of the invention into a band which can be situated upon a bodily limb.

### DETAILED DESCRIPTION OF THE INVENTION

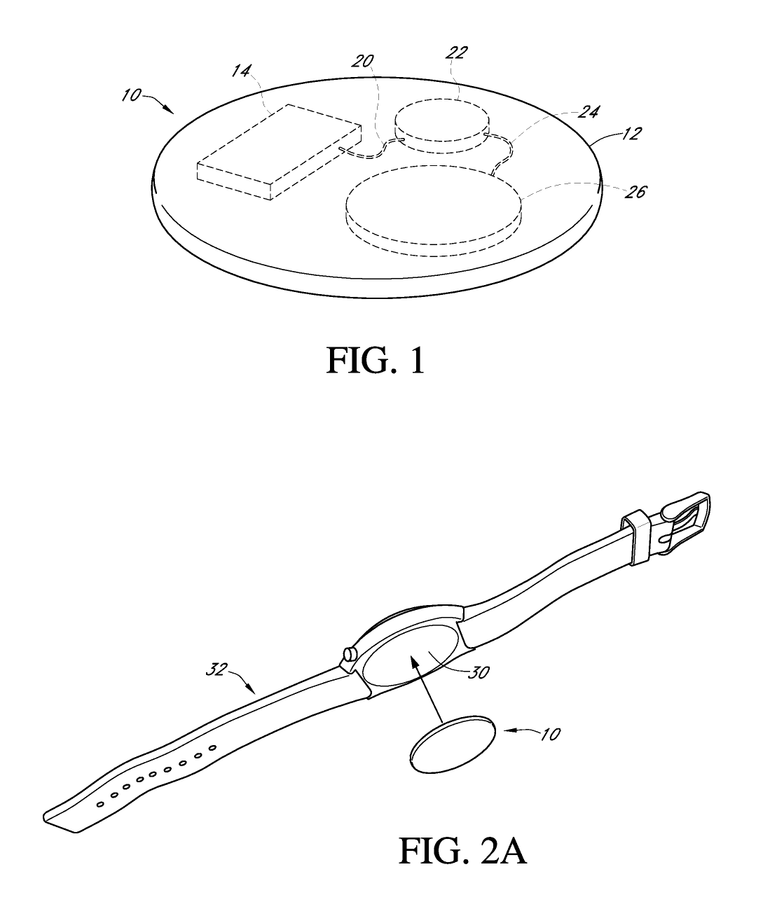

Referring to the drawings, FIG. 1 shows an embodiment of the invention notification device 10, WEARABLE COIN-SIZED SENSORY DEVICE PROVIDING IMMEDIATE WIRELESS NOTIFICATION OF ACTIVITIES OCCURRING ON SEPARATE ELECTRONIC DEVICES. Within the housing 12 of the notification device 10 is contained a receiver 14, which wirelessly receives a signal 16 from any separate electronic device so constructed or configured, such as a personal digital assistant 18 shown in FIG. 3. Also contained in the housing 12 is power source 22, which drives receiver 14 via connection 20. Power source 22 also drives an indication module 26 via connection 24. Indication module 26 in turn provides a silent tactile indication 28 (shown in FIG. 3) to the user, as housing 12 is in contact or near contact with the user's skin.

It will be understood that the separate electronic devices which produce wireless signals receivable by notification device 10 include as many of the user's separate electronic devices which are constructed or configured to emit a wireless signal of occurrences on such separate electronic devices. It will also be understood that the specific nature of the separate electronic devices which can produce such wireless signal is not critical to the invention and can comprise any of the plethora of available electronic devices, such as cellular telephones, walkie-talkies, hand-held computers, electronic mail devices, text message devices, digital music players, portable televisions, portable cameras and video recorders, as well as household appliances, televisions, room lights, thermostats, smoke alarms and gas meters, for example, which have been equipped with a module that can emit wireless signals of occurrences on such electronic devices and which has the ability to wirelessly reach, directly or indirectly, notification device 10.

It shall further be understood that wireless signal 16 from the user's separate electronic device, such as personal digital assistant 18, can be any suitable wireless protocol, such as but not limited to WiBree™ (also known as “ULP [Ultra Low Power] Bluetooth”), Bluetooth™, ZigBee™, Z-Wave™ or 802.15.4, as well as any combination of wireless protocols. Further specific examples of usable protocols need not be presented here as they will be apparent to one skilled in the art.

Power source 22 is comprised of any such source appropriate for the size of notification device 10 and the amount of power needed, such as but not limited to a rechargeable lithium or other battery, or a kinetic energy module.

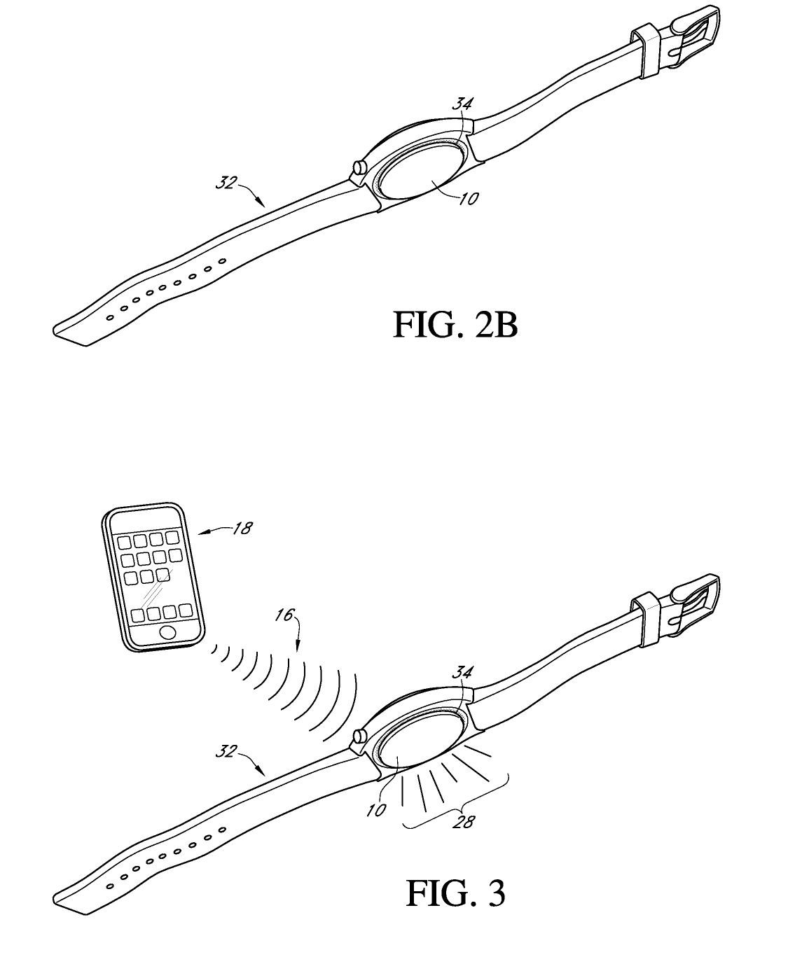

A first embodiment of notification device 10 is shown in FIGS. 2A and 2B, wherein notification device 10 can be affixed to the skin side of any item worn on the user's body, such as but not limited to the housing 30 on the back of a watch 32 worn by the user. In such embodiment the notification device 10 is affixed to a watch 32 using any affixing means 34, such as but not limited to a permanent or non-permanent sticking adhesive, or a magnet.

While FIGS. 2A and 2B show the notification device 10 as affixed to a watch 32, notification device 10 could just as easily be affixed to any item worn on or adjacent to the user's body, such that notification device 10 is in contact or near contact with the user's skin. Such include but are not limited to necklaces, bracelets and anklets.

FIG. 3 shows one system and method utilized by notification device 10 consistent with the first embodiment. An occurrence on personal digital assistant 18, such as a calendar event, triggers signal 16 to the notification device 10, affixed to watch housing 30 by any affixing means 34. Driven by power source 22, the receiver 14 senses signal 16, which triggers indication module 26, also driven by power source 22, producing tactile indication 28. Since the user's skin is in contact or near contact with notification device 10, the user is immediately notified that an event on personal digital assistant 18 has occurred.

Tactile indication 28 may be of any tactile type, including but not limited to vibration. In such embodiment indication module 26 is a propeller-style coin vibration motor, although is not limited to such.

Further, notification device 10 can be configured such that the tactile indication 28 is altered depending upon the nature of the event occurring on the separate electronic device. For example, notification device 10 can be configured such that a telephone call produces two vibrations, an e-mail produces three vibrations, a text produces two long vibrations, and an emergency (such as an oven remaining on for too many hours) produces more continuous vibrations.

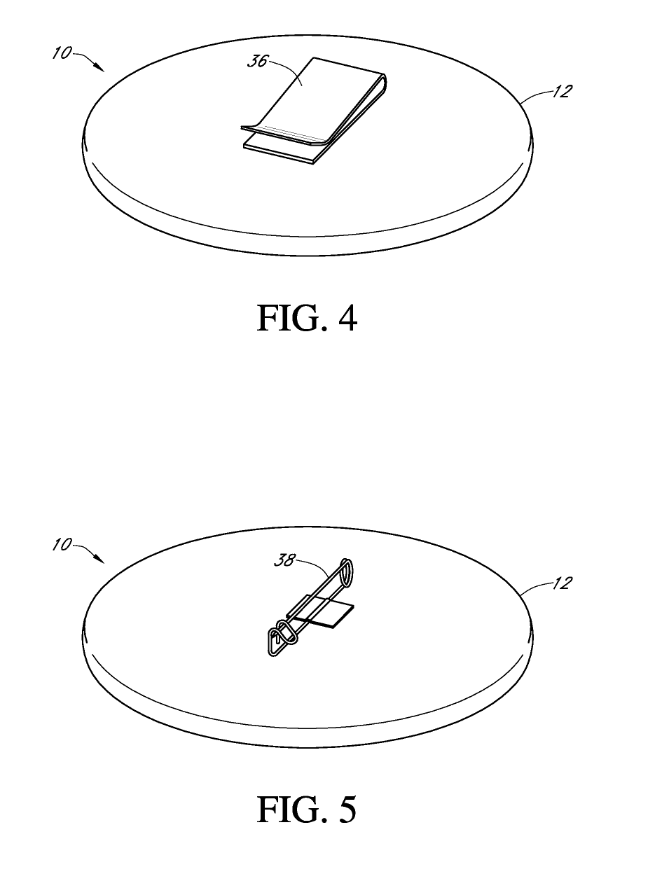

A second embodiment is shown in FIG. 4, wherein notification device 10 utilizes a clip 36 which is attached to housing 12, allowing the user to affix notification device 10 to plethora items worn on or adjacent to the user's body, such as but not limited to clothes, undergarments, hats, shoes and belts.

A third embodiment is shown in FIG. 5, wherein notification device 10 utilizes a safety-style pin 38, allowing the user to affix notification device 10 to other item worn by the user which is in contact or near contact with the user's skin.

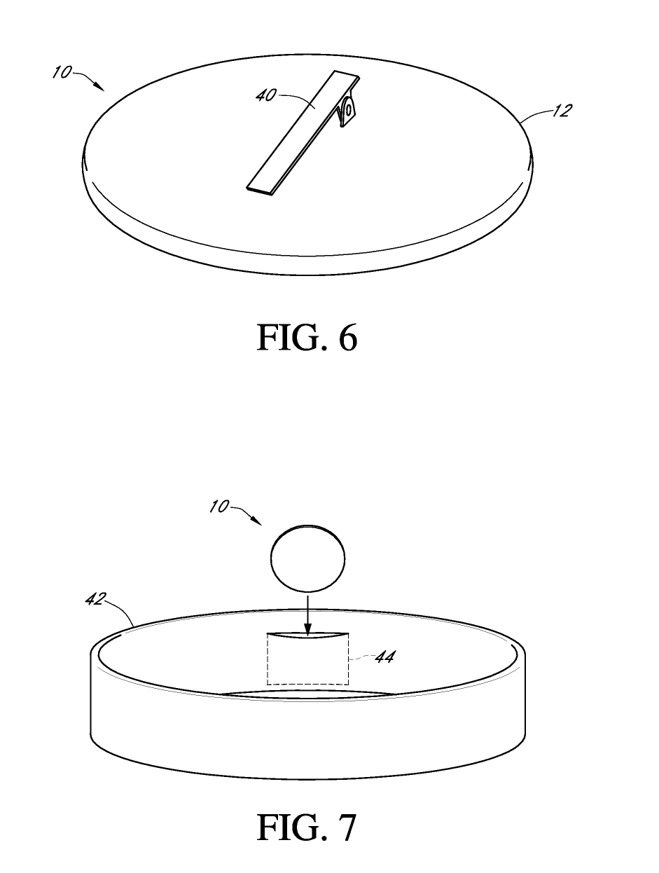

A fourth embodiment is shown in FIG. 6, wherein notification device 10 utilizes a clasp 40, allowing the user to affix notification device 10 to any item worn by the user which is in contact or near contact with the user's skin.

A fifth embodiment is shown in FIG. 7, wherein notification device 10 can be slid into a pocket 44 an elastic or any other type of band 42, allowing the user to slip such band 42 holding notification device 10 onto parts of the user's body, such as but not limited to a wrist, arm, leg, ankle or neck.

In summary, the present invention constitutes a notification device 10 that can receive immediately tactile alerts occurring on separate electronic devices, such that the notification device does not require the user to replace, reconfigure or retrofit items already possessed by the user and worn on the body, and which does not disturb others in the vicinity of the user.

While the above description contains many specificities, these should not be construed as limitations on the scope of any embodiment, but as exemplifications of the presently preferred embodiments thereof. Many other ramifications and variations are possible within the teachings of the various embodiments. For example, the tactile indication 28 produced by the notification device 10 could constitute a dimple protruding from the device housing 12 rather than a vibratory indication, as contemplated in an embodiment above. Thus the scope of the invention should be determined by the appended claims and their legal equivalents, and not by the examples given.

1. A notification device for a user of one or more separate electronic devices, such notification device providing an immediate silent or near-silent tactile indication to the user of activities associated with the separate electronic devices, such notification device comprising:
a coin-sized or smaller housing, physically unconnected to the separate electronic devices, such that the notification device can be worn, or affixed to an item, in contact or near-contact with the user's skin; and
such housing containing inside a means for wirelessly receiving signals from the separate electronic devices of activities associated therewith, a means for providing a silent or near-silent tactile indication to the user of such signals, and a means for powering such tactile indication.

2. The notification device of claim 1 wherein the device can be worn or affixed using a clip attached to the housing.

3. The notification device of claim 1 wherein the device can be worn or affixed using a pin attached to the housing.

4. The notification device of claim 1 wherein the device can be worn or affixed using a clasp.

5. The notification device of claim 1 wherein the device can be worn or affixed using an adhesive.

6. The notification device of claim 1 wherein the device can be worn or affixed using a magnet.

7. The notification device of claim 1 wherein the device can be worn or affixed using a band, elastic or otherwise.

8. The notification device of claim 1 wherein the means for wirelessly receiving signals from the separate electronic devices utilizes the WiBree™ (also known as “ULP [Ultra Low Power] Bluetooth”) technology protocol.

9. The notification device of claim 1 wherein the means for wirelessly receiving signals from the separate electronic devices utilizes a Bluetooth™ technology protocol.

10. The notification device of claim 1 wherein the means for wirelessly receiving signals from the separate electronic devices utilizes a ZigBee™ technology protocol.

11. The notification device of claim 1 wherein the means for wirelessly receiving signals from the separate electronic devices utilizes a Z-Wave™ technology protocol.

12. The notification device of claim 1 wherein the means for wirelessly receiving signals from the separate electronic devices utilizes the IEEE 802.15.4 technology protocol.

13. The notification device of claim 1 wherein the means for wirelessly receiving signals from the separate electronic devices utilizes a combination of wireless protocols.

14. The notification device of claim 1 wherein the means for powering the tactile indication is a battery.

15. The notification device of claim 1 wherein the means for powering the tactile indication is kinetic energy.

16. The notification device of claim 1 wherein the means for providing a silent or near-silent tactile indication to the user of the signals on separate electronic devices is vibration.

17. A notification system comprising:
one or more separate electronic devices having the ability to transmit wireless signals of activities associated with such devices; and
an immediate notification device providing a silent or near-silent tactile indication to the user of activities associated with the separate electronic devices,
wherein the notification device is comprised of a coin-sized or smaller housing, physically unconnected to the separate electronic devices, such that the notification device can be worn, or affixed to an item, in contact or near-contact with the user's skin, and
wherein such housing contains inside a means for wirelessly receiving signals from the separate electronic devices of activities associated therewith, a means for providing a silent or near-silent tactile indication to the user of such signals, and a means for powering such tactile indication.

18. The system of claim 17 wherein the device can be worn or affixed using a clip attached to the housing.

19. The system of claim 17 wherein the device can be worn or affixed using a pin attached to the housing.

20. The system of claim 17 wherein the device can be worn or affixed using a clasp.

21. The system of claim 17 wherein the device can be worn or affixed using an adhesive.

22. The system of claim 17 wherein the device can be worn or affixed using a magnet.

23. The system of claim 17 wherein the device can be worn or affixed using a band.

24. The system of claim 17 wherein the means for wirelessly receiving signals from the separate electronic devices utilizes the WiBree™ (also known as “ULP [Ultra Low Power] Bluetooth”) technology protocol.

25. The system of claim 17 wherein the means for wirelessly receiving signals from the separate electronic devices utilizes a Bluetooth™ technology protocol.

26. The system of claim 17 wherein the means for wirelessly receiving signals from the separate electronic devices utilizes a ZigBee™ technology protocol.

27. The system of claim 17 wherein the means for wirelessly receiving signals from the separate electronic devices utilizes a Z-Wave™ technology protocol.

28. The system of claim 17 wherein the means for wirelessly receiving signals from the separate electronic devices utilizes the IEEE 802.15.4 technology protocol.

29. The system of claim 17 wherein the means for wirelessly receiving signals from the separate electronic devices utilizes a combination of wireless protocols.

30. The system of claim 17 wherein the means for powering the tactile indication is a battery.

31. The system of claim 17 wherein the means for powering the tactile indication is kinetic energy.

32. The system of claim 17 wherein the means for providing a silent or near-silent tactile indication to the user of the signals on separate electronic devices is vibration.

33. A method of immediately notifying a user of one or more separate electronic devices of activities associated with such devices, the method comprising the steps of
providing a coin-sized or smaller notification device, that can be worn or affixed to an item in contact or near-contact with the skin of a user of one or more separate electronic devices which generate wireless signals when various activities on such separate electronic devices occur;
providing in the notification device a receiver of wireless signals generated by the separate electronic devices;
providing in the notification device a silent or near-silent tactile indicator such wireless signals have been received by such notification device.

34. The method of claim 33 and further comprising the step of receiving on the notification device signals generated by the separate electronic devices via Bluetooth™ technology.

35. The method of claim 33 and further comprising the step of receiving on the notification device signals generated by the separate electronic devices via ZigBee™ technology.

36. The method of claim 33 and further comprising the step of receiving on the notification device signals generated by the separate electronic devices via WiBree™ technology.

37. The method of claim 33 and further comprising the step of causing the notification device to issue a tactile indication via vibration.
